(19) United States
(12) Patent Application Publication
(10) Pub. No.: US 2016/0062783 A1
(43) Pub. Date: Mar. 3, 2016

(54) Managing Virtual Machines

(71) Applicant: salesforce.com, inc., San Francisco, CA (US)

(72) Inventor: Andrey Falkco, Lafayette, CA (US)

(21) Appl. No.: 14/631,381

(22) Filed: Feb. 25, 2015

Related U.S. Application Data
(60) Provisional application No. 62/041,972, filed on Aug. 26, 2014.

(51) Int. Cl. G06F 9/455

(52) U.S. Cl. CPC G06F 9/45558; G06F 2009/45595; G06F 2009/45575

(57) ABSTRACT

A virtual machine manager program or process may be executable on a host machine. The same host may support one or more virtual machines. The VM manager may include tools for accessing a pseudo console interface of a virtual machine. The tools may include a writer component to write a textual message or command to a VM pseudo console under control of the VM manager. Conversely, a reader component may read messages from the VM pseudo console. Direct access to the VM pseudo consoles may be used to advantage to update a network address of a new VM, update security keys, and other functions. Embodiments may be operated in parallel to simplify and accelerate configuration of multiple VMs. A VM manager also may be used to test PXE installs without requiring separate hardware for each installation.

### RELATED APPLICATIONS

This application is a non-provisional of U.S. Provisional Patent Application No. 62/041,972—filed Aug. 26, 2014 and incorporated herein by this reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

The technology disclosed herein relates to managing virtual machines.

### BACKGROUND

“Cloud computing” services provide shared resources, software, and information to computers and other devices upon request or on demand. Cloud computing typically involves the over-the-Internet provision of dynamically-scalable and often virtualized resources. Technological details can be abstracted from end-users, who no longer have need for expertise in, or control over, the technology infrastructure “in the cloud” that supports them. In cloud computing environments, software applications can be accessible over the Internet rather than installed locally on personal or in-house computer systems.

In some networked environments, including without limitation a cloud environment, a plurality of application servers may be deployed to execute applications and for other functions. Workloads may be distributed across the application servers to improve performance for multiple concurrent user organizations or individuals. Virtual machines may be instantiated on one or more servers and configured to implement applications, messaging, or other functions.

### BRIEF DESCRIPTION OF THE DRAWINGS

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1 shows a block diagram of an example environment in which an on-demand database service can be used according to some implementations.

FIG. 2 shows a block diagram of one example implementation of selected elements of FIG. 1.

FIG. 3 is a simplified conceptual illustration of creating new virtual machines on an application server from a base OS image.

FIG. 4A is a flow diagram of an example of a process for initializing new virtual machines in accordance with some implementations.

FIG. 4B is a flow diagram of an example of a process for testing a PXE install on a virtual machine in accordance with some implementations.

FIG. 5 shows a block diagram of an example of a virtual machine manager program interacting with virtual machines on a host server in accordance with some implementations.

FIG. 6 shows a simplified communication diagram of an example of a virtual machine manager program operating on a host server in accordance with some implementations.

FIG. 7 shows a block diagram of an example of a virtual machine manager program arranged for testing a PXE install on a virtual machine.

### DETAILED DESCRIPTION

Examples of systems, apparatus, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B or C” is intended to include the possibilities of “A,” “B,” “C,” “A and B,” “B and C,” “A and C” and “A, B and C.”

Some implementations described and referenced herein are directed to systems, apparatus, computer-implemented methods and computer-readable storage media for managing virtual machines. The disclosed technology can be used for initializing virtual machines, changing their network addresses and other configurations, injecting security keys, and other functions. The disclosed technology can be used for testing PXE install software without requiring separate physical hardware.

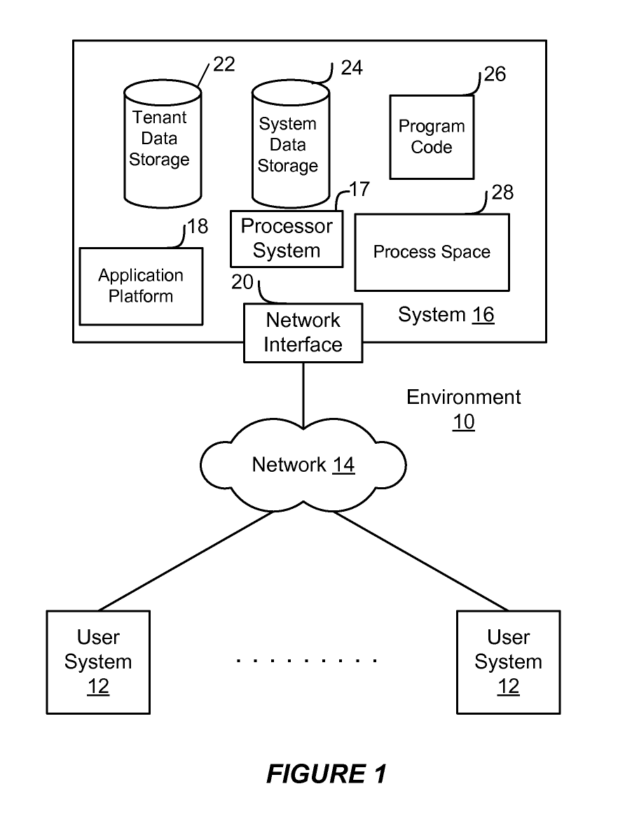

FIG. 1 shows a block diagram of an example of an environment 10 in which an on-demand database or similar service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications. Applications may be developed by the provider of the on-demand database service, by users accessing the on-demand database service via user systems 12, or by third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 may be configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a wearable device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

In some implementations of a cloud-based system, or other on-demand service, many of the various processes, including for example, system processes and individual tenant processes, may communicate with other processes or databases using messaging. Messaging can be used to provide an asynchronous communication system. That is, the sender and the receiving need not access the messaging system at the same time. A message “sender” can send a message into the messaging system, and then proceed to other tasks without having to wait for a reply. Similarly, a receiver can receive the message at a later time without direct interaction with the sender. In some systems, some messages may be processed by a “message broker” which is an entity responsible for receiving the message, holding it until delivery, and delivering it to the appropriate receiver(s). Various messaging protocols may be used. One example is an open standard application layer protocol called the Advanced Message Queuing Protocol (AMQP), wire-level protocol. Apache Qpid™ among others provide messaging tools that implement the AMQP protocol. A message broker may store pending messages in a message queue (MQ). Messaging may be used for example, for inter-process communication, or for inter-thread communication within the same process. Message queues may be used for messaging, the passing of control or passing of content. Message queues may have implicit or explicit limits on the size of data that may be transmitted in a single message, and limits on the number of messages that may remain outstanding on a message queue (the “message queue depth”).

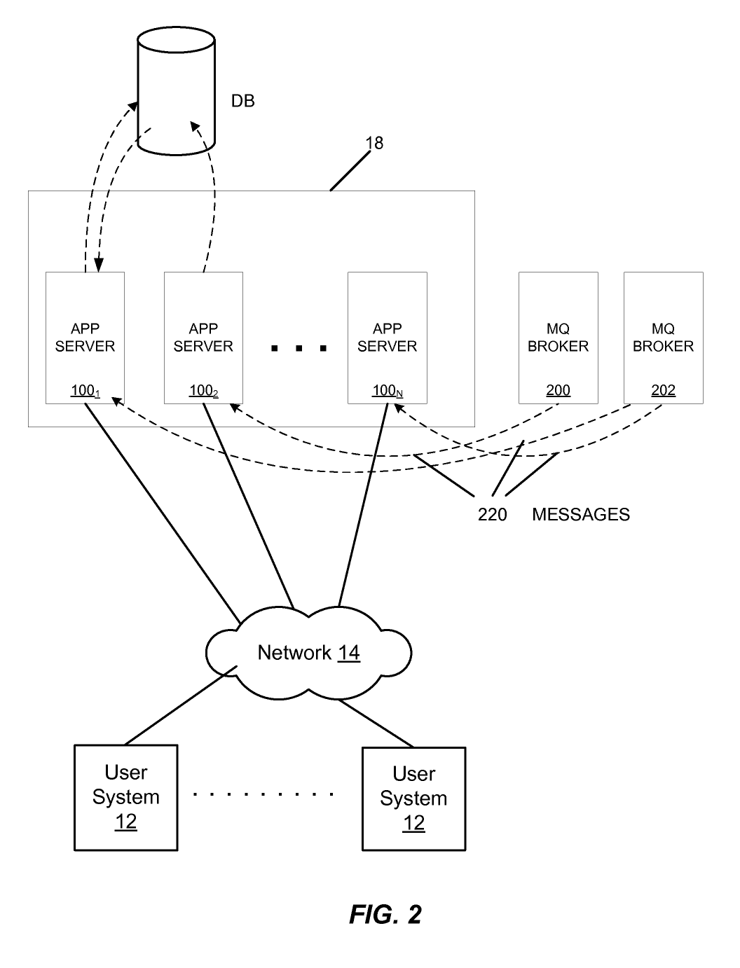

FIG. 2 shows a block diagram of one example implementation of selected elements of FIG. 1. In particular, the application platform of FIG. 1 may include one or more application servers 100. One or more of the application servers 100 may implement or “host” one or more virtual machines (VM). The use of virtual machines is not limited to application servers; they may be used for a variety of different functions on a variety of different hosts. We show VMs on application servers for illustration. To take just one additional example, one or more of the message queue brokers 200, 202 may host VMs in some embodiments. Messages 220 may be implemented using various messaging protocols, including but not limited to those mentioned above.

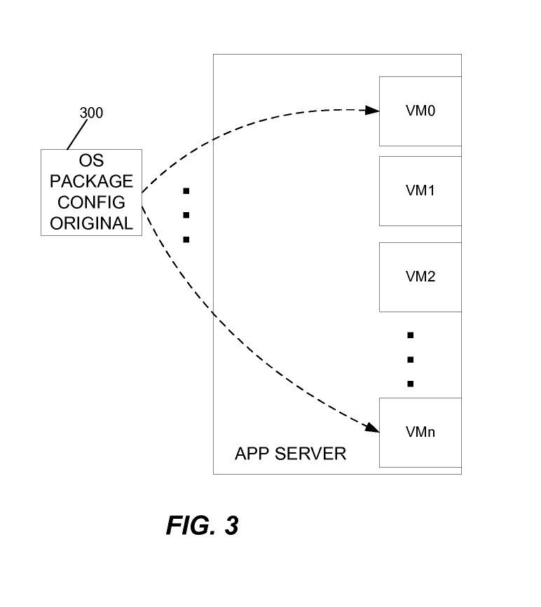

FIG. 3 is a simplified conceptual illustration of a process of creating (also called “instantiating” or “cloning”) new virtual machines on a host server, for example, an app server, from a base OS image 300. The base image 300 may comprise an OS (Operating System) package and configuration information for operation on a new VM. In general, the base image is carefully maintained, and changed only when necessary. The base image is copied into each VM. Changes to the OS may have to be disseminated to a large number of VMs that are in production on a large number of hosts, which in turn may be distributed over many separate network nodes. Dissemination of updates is described further later. First we describe initialization of new VMs when first created.

When a new VM is initialized with the base image, that image includes a network address, for example, an IP address, coded into a networking layer of the image. Therefore each new VM0 . . . VMn receives the same address, which of course would lead to conflicts in operation. The individual addresses may be changed before releasing the VM or host into production. The initial address may be used to access the VM to change the network address. Then at least the networking layer must be restarted. It may be advantageous to do this work rapidly in order to “spin up” new resources to meet the needs of new customers or growing demands of existing customers. However, these changes must be done for one VM at a time as they all begin with the same address, and different (unique) addresses are needed.

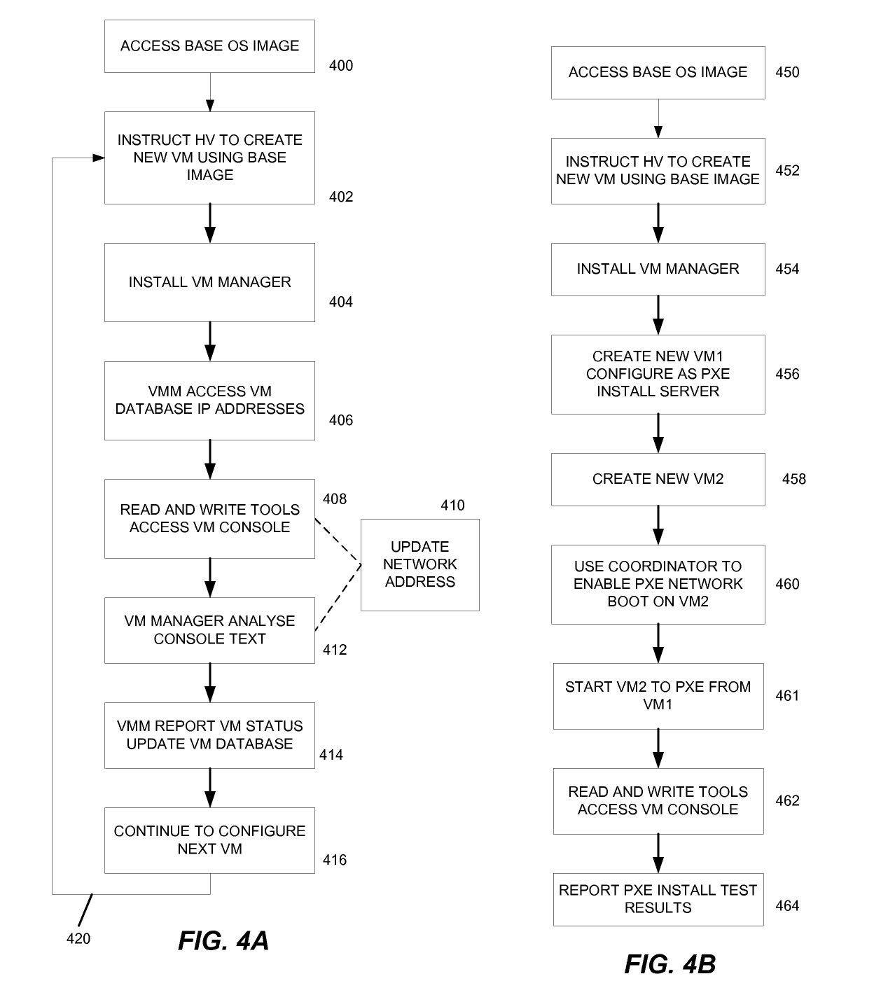

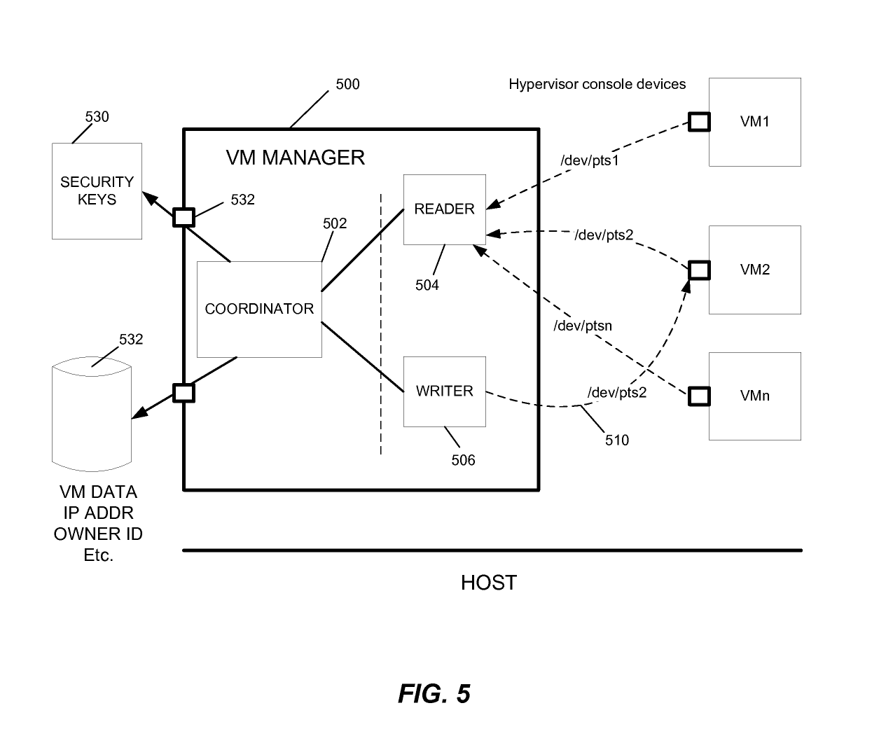

FIG. 4A is a flow diagram of an example of a process for initializing new virtual machines in accordance with some implementations. In FIG. 4A, the illustrative process begins with accessing the base OS image, block 400. Next, the process instructs a hypervisor (executing on the host) to create a new VM using the base image, block 402. Before or after the new VM is created, a software program or module that we call a VM Manager is installed on the host, block 404. The VM Manager may include, or have access to, a VM Database that stores information for each VM in the system, see block 406; for example, the respective network address of each VM. The term Database is used herein in its broadest sense to mean a collection of information in any machine readable form. It need not be a formal database, but may be any table, queue, file, etc. An example is the VM datastore 532 in FIG. 5. We also refer herein to IP addresses as a common but non-limiting example of a network address.

Referring again to FIG. 4A, read and write software agents or “tools” access the VM console to read and to write text messages, respectively, block 408. The read and write tools may correspond to the reader 504 and writer 506, respectively, in an embodiment illustrated in FIG. 5. The read and write tools preferably interact with the VM via a console interface to update a network address of the VM, block 410, or carry out other functions. A hypervisor may expose the console as follows. The hypervisor provides a pts (pseudo terminal device) for a virtual machine responsive to a request to create a console for the VM. The hypervisor identifies a location of the device. e.g., “/dev/pts/11”, so that a routine (for example, the reader tool) can communicate with the VM's console by accessing the path “/dev/pts/11”. That path /dev/pts/11 appears similar to an operating system path, but in fact /dev/pts is a directory and “11” is a special file type:

$ file /dev/pts/11
/dev/pts/11: character special (136/11).

The write agent is configured to send sets of bytes to the console “path” (file) that represent strings, integers, etc. Conversely, the read agent is configured to read information from the console file, and interpret it or pass it on, for example, to a VM Manager program. Returning to the flow diagram of FIG. 4A, it refers to a “VM Manager” or “VMM.” A VMM program may include read and write tools for accessing a console, as further explained below. As noted, the read and write tools access the VM console, block 408, and the VMM analyzes text received from the console, block 412. Based on that analysis, the VMM may report VM status or update a VM database, block 414. The disclosed process may then continue to create and configure a next VM, block 416, proceeding via loop via 420. Note that multiple instances of a VMM may execute in parallel, thus configuring multiple VMs in parallel, by accessing a database to acquire a unique network address for each VM as indicated in block 406.

FIG. 5 shows a block diagram of an example of a virtual machine manager program (“VM Manager”) 500 interacting with virtual machines on a host server in accordance with some implementations. Here, the VM Manager 500 includes a coordinator component 502, coupled to a reader component 504 and a writer component 506. The reader component 504 is arranged to access a VM console utilizing the hypervisor as explained above. For example, a VM1 in the drawing is accessed via path /dev/pts1 by the reader, in order to read textual information generated at the console by the corresponding VM. Similarly, the reader can access /dev/pts2 to read the console of VM2. Conversely, the writer component 506 is configured to write text to the console of any of the running VMs. For illustration, the writer is shown as writing text to the console designated /dev/pts2 indicated by dashed line 510. The coordinator 502 may be arranged to initiate sending commands or other input to a VM console utilizing the writer component 506. Conversely, the coordinator 502 may be arranged to interpret text received from a VM console via the reader component 504. The coordinator may be a part of, or controlled by the VMM 500. In one example, the coordinator may be written in the Python language.

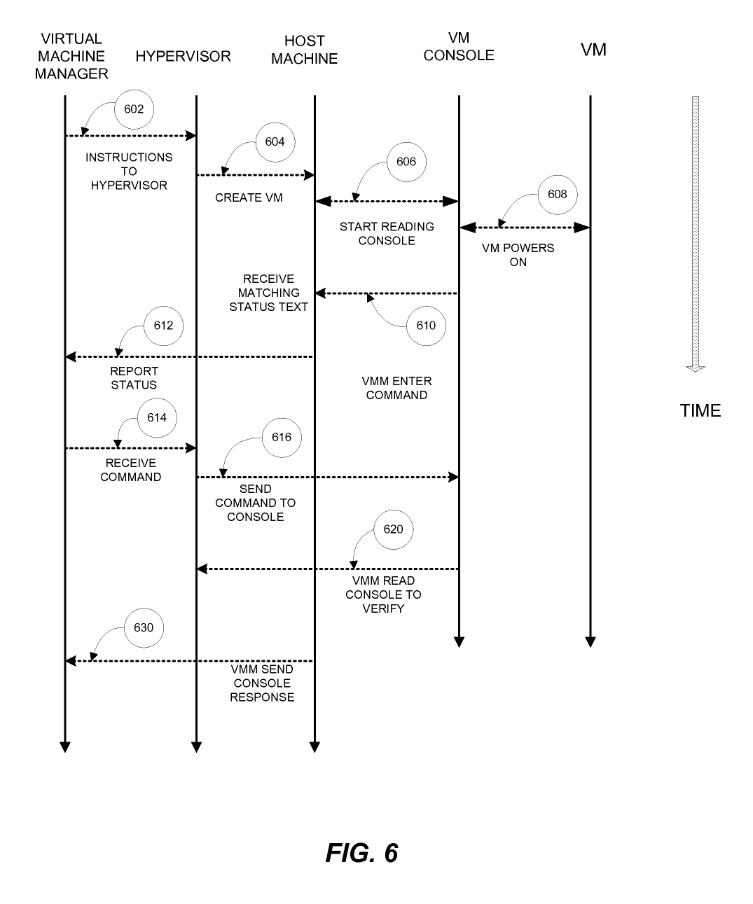

FIG. 6 shows a simplified communication diagram of an example of a virtual machine manager program (VMM) operating on a host server in accordance with some implementations. This illustrates general operation of the VMM. In the diagram, the vertical dimension corresponds to elapsed time, starting from the top of the diagram. To begin, a management interface (for example, a VM Manager) generates an instruction 602 to a hypervisor to create a new VM. The hypervisor then creates a new VM on the host machine, dashed line 604. Then the VMM may start reading the VM console, 606. The VM may power on subsequently, 608 and the change may be reflected at the console. At 610, the host receives status text from the console, and this results in a status report (via the hypervisor) to the VMM, dashed line 612.

The VMM may initiate a command, 614, which may be sent to the VM console, see dashed line 616, for example, using the tools and processes described above. The VMM may then read the console, dashed line 620, to verify receipt of the command or to acquire any other response from the console. The VMM may pass on the console response as appropriate, 630.

Interactions with a VM via a VM console may be used to update a VM network address as discussed above, and for other functions. Another example is to inject or update security information, such as a cryptographic key, into a VM. In some embodiments, these operations may be carried out by a VM Manager (VMM) of the type illustrated in FIG. 5. Referring again to FIG. 5, the VMM 500 may have access to a source of security keys 530 for this purpose. The VMM may communicate with a VM console to inject a selected security key using the methods described above with regard to FIGS. 4A, 5 and 6.

### Preboot eXecution Environment (“PXE”) Install and Testing

Another application of the VMM is for use in connection with PXE (pronounced Pixey) testing. The Preboot eXecution Environment (PXE) specification describes a standardized client-server environment that boots a software assembly, retrieved from a network, on PXE-enabled clients. Traditionally, testing a PXE install requires installing the software on an actual physical hardware. Doing so is expensive because it requires acquisition of the physical hardware and setup. Further, if the PXE install does not operate correctly, trouble shooting the physical server may be challenging.

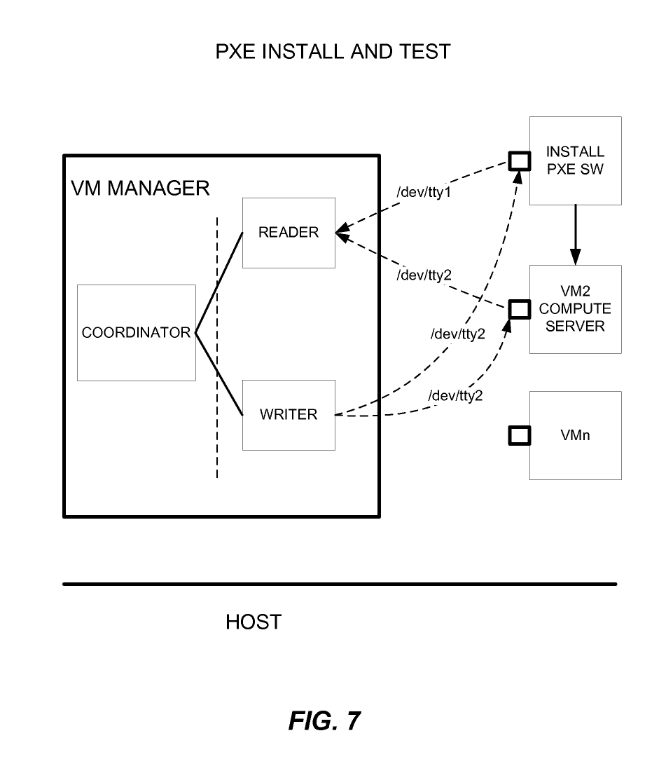

FIG. 7 shows a block diagram of an example of a virtual machine manager program (VMM) arranged for testing a PXE install without requiring separate physical hardware. Rather, a virtual machine may be used to test a PXE install, as follows. As shown in FIG. 7, a PXE install image is stored in a first VM, and that first VM then installs the PXE on a second VM. Referring now to FIG. 4B, a flow diagram of such a process is shown. To begin, the process has access to a base OS image, block 450. The process instructs a hypervisor to create a new VM using the base image, block 452. A VM Manager, of the type described above, is installed on the same host or in communication with it, block 454. The hypervisor creates a new VM1 and configures it as a PXE installer, block 456. Then, VM1 is used to create (install) a new VM2, block 458. More specifically, a coordinator within or coupled to the VMM enables a PXE network boot on VM2, see block 460. Then VM2 is started, and PXE installs from VM1, block 461. The read and write tools may be used to access the VM2 console to confirm and test the install, block 462. Finally, the VMM may report PXE install test results, block 464.

In a case that VM2 does not come up or respond properly, it indicates the PXE install did not succeed. In order to troubleshoot the PXE software, it may be valuable to capture any error messages immediately from the console by using the reader tool. This can be done my monitoring the console as explained above. In the example of FIG. 6, note that console reading as indicated at 606 may begin before the VM actually powers on. This process enables PXE testing without having to conduct the PXE install on physical hardware. This process can be conducted quickly and easily for every change to a PXE install, to ensure that all is well, again without having to obtain and provision physical hardware.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which an on-demand database service environment is implemented in a system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM and the like without departing from the scope of the implementations claimed.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Additionally, any of the software components or functions described in this application can be implemented as software code to be executed by one or more processors using any suitable computer language such as, for example, Java, C++ or Perl using, for example, existing or object-oriented techniques. The software code can be stored as a computer- or processor-executable instructions or commands on a physical non-transitory computer-readable medium. Examples of suitable media include random access memory (RAM), read only memory (ROM), magnetic media such as a hard-drive or a floppy disk, or an optical medium such as a compact disk (CD) or DVD (digital versatile disk), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While some implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

1. A computer program stored on a tangible medium for managing virtual machines on a host server, the computer program comprising a set of instructions operable to cause a processor to:
instruct a hypervisor running on the host to create a VM using a base image;
access a pseudo console of the VM utilizing the hypervisor;
send a command to the VM via the pseudo console;
receive text output from the pseudo console responsive to the command; and
report a status of the VM based on the received text output.

2. The computer program according to claim 1 wherein the set of instructions is further operable to cause the processor to change a network address of the VM and restart a networking layer of the VM after changing the network address.

3. The computer program according to claim 1 wherein the network address comprises an IP address.

4. The computer program according to claim 1 and further operable to cause the processor to inject a security key into the VM via the pseudo console.

5. The computer program according to claim 1 and further operable to cause the processor to update login credentials of the VM via the pseudo console.

6. The computer program according to claim 1 and further operable to cause the processor to monitor an internal status of the VM via the pseudo console, capture text messages issued to the pseudo console by the VM, and interpret the text messages to detect a change in the status of the VM.

7. The computer program according to claim 6 further configured to detect a request to shut down the VM, via the pseudo console, before the hypervisor shuts down the VM.

8. The computer program according to claim 1 and further operable to cause the processor to execute multiple instances of the computer program, each instance configured to monitor a respective one of multiple VMs running on the host, at least two of the instances running in parallel.

9. The computer program according to claim 8 and further operable to cause the processor to report to a management interface responsive to a predetermined change in internal status of one or more of the VMs.

10. A computer program stored on a tangible medium, the computer program comprising a set of instructions operable to cause a processor to:
instruct a hypervisor running on the host to create a VM;
determine a location of a pseudo console of the VM;
access the VM, via the pseudo console, to configure the VM as a PXE install server;
instruct the hypervisor to create a second VM;
configure the second VM's virtual network device to use PXE;
access a pseudo console of the second VM utilizing the hypervisor; and
utilizing the pseudo console of the second VM, monitor and validate operation of the PXE install.

11. The computer program according to claim 10 and further operable to cause the processor to analyze a failure of the PXE install based on communicating with the pseudo console to acquire internal state information of the second VM.

12. The computer program according to claim 10 and wherein the processor further implements a coordinator component, and
the processor interacts with the VM pseudo consoles utilizing the coordinator component.

13. The computer program according to claim 10 and wherein the processor further implements a reader tool to acquire data from the VM pseudo consoles and a writer tool to write data to the pseudo consoles.

14. The computer program according to claim 10 including configuring the VMM to monitor the pseudo console of the second VM during startup of the second VM to capture an error message for use in debugging the PXE install.

15. A VM Manager computer program stored on a tangible medium for managing virtual machines on a host, the VMM computer program comprising a set of instructions operable to cause a processor to:
implement a coordinator component, the coordinator component configured to access a VM data store; and
interact with a VM via a corresponding pseudo console of the VM, to configure the VM based on data acquired from the VM data store.

16. The computer program according to claim 15 wherein the processor further implements a reader tool for capturing data from the pseudo console of the VM, and passing the captured data to the coordinator component.

17. The computer program according to claim 15 wherein the processor further implements a writer tool for writing data to the pseudo console of the VM, wherein the writer tool is arranged to receive data from the coordinator component for writing to the pseudo console.

18. The computer program according to claim 15 wherein the coordinator component is configured to access a source of security keys; and the VM Manager is further arranged to utilize the coordinator component to acquire a security key from the source and update the VM with the acquired security key.

19. The computer program according to claim 15 wherein the data acquired from the VM data store includes an IP address.

20. The computer program according to claim 15 wherein the pseudo console of the VM is exposed by a hypervisor executing on the host.
